(19) United States
(12) Patent Application Publication
(10) Pub. No.: US 2026/0299143 A1
(43) Pub. Date: Oct. 1, 2026

(54) CURVED EDGE RADIATION DETECTOR, COLLIMATOR, AND IMAGING SYSTEM INCLUDING SAME

(71) Applicant: VAREX IMAGING CORPORATION, Salt Lake City, UT (US)

(72) Inventors: Josh M. Star-Lack, Palo Alto, CA (US); Ivan P. Mollov, Mountain View, CA (US); Robyn Fayth Tal, Abiquiu, NM (US)

(73) Assignee: VAREX IMAGING CORPORATION, Salt Lake City, UT (US)

(21) Appl. No.: 19/451,786

(22) Filed: Jan. 16, 2026

Related U.S. Application Data
(60) Provisional application No. 63/778,245, filed on Mar. 26, 2025.

(51) Int. Cl. G01T 1/17; G01N 23/04

(52) U.S. Cl. CPC G01T 1/17; G01N 23/04; G01N 2223/501

(57) ABSTRACT

Radiation detectors with curved edges, collimators, and radiation imaging systems including the same are disclosed. A radiation detector can include a radiation sensitive area and a housing at least partially surrounding the radiation sensitive area. The radiation sensitive area can be configured to detect incident radiation. The radiation sensitive area can include a curved edge at least partially defining the radiation sensitive area. The housing can include a concave curved edge.

### CROSS-REFERENCE TO RELATED APPLICATIONS

This application claims priority to U.S. Patent Application No. 63/778,245, filed 26 Mar. 2025, the entire disclosure of which is hereby incorporated by reference.

### FIELD

The described embodiments relate generally to radiation imaging detectors, collimators, and systems. More particularly, the described embodiments relate to radiation imaging detectors that include at least one curved edge, collimators for shaping an X-ray area with at least one curved edge, and radiation imaging systems including the same.

### BACKGROUND

Radiation detectors can be used to generate two-dimensional images or video in response to incident radiation. Radiation detectors can be used in a variety of contexts, including medical and industrial imaging. Radiation detectors can generally have rectangular shapes and collimators that shape X-rays directed towards the radiation detectors can have complementary rectangular shapes. In some applications, radiation detectors can be used to scan curved objects and can be placed adjacent to the scanned curved objects. In such applications, rectangular-shaped radiation detectors can miss data or can result in undesirable forces being applied to the scanned objects in order to obtain quality scans of the objects, which can harm or otherwise damage the objects.

### SUMMARY

An aspect of the present disclosure relates to a radiation detector including a radiation sensitive area and a housing. The radiation sensitive area can be configured to detect incident radiation. The radiation sensitive area can include a concave curved edge at least partially defining the radiation sensitive area. The housing can at least partially surround the radiation sensitive area and can include a concave curved surface.

In one or all examples, the housing of the radiation detector can further include a first straight edge and a second straight edge opposite the first straight edge. The concave curved edge of the housing can extend between the first straight edge and the second straight edge.

In one or all examples, the concave curved edge of the housing can be symmetrical about an axis arranged along a length of the concave curved edge of the housing. In one or all examples, the concave curved edge of the housing can be asymmetrical about an axis arranged along a length of the concave curved edge of the housing.

In one or all examples, the concave curved edge of the radiation sensitive area can have a complementary shape to the concave curved edge of the housing. In one or all examples, the radiation detector can further include a radiation transparent panel over the radiation sensitive area and coupled to the housing. The radiation transparent panel can include a curved edge having a complementary shape to the concave curved edge of the housing.

Another aspect of the present disclosure relates to a radiation collimator including one or more collimation components configured to shape incident radiation through an opening. The opening can include a first straight edge, a second straight edge oriented opposite the first straight edge, and a curved edge extending between the first straight edge and the second straight edge.

In one or all examples, the curved edge can be symmetrical about an axis arranged along a length of the concave edge. In one or all examples, the curved edge can be asymmetrical about an axis arranged along a length of the concave edge. In one or all examples, a radius of the curved edge can be adjustable. In one or all examples, a symmetry of the curved edge can be adjustable. In one or all examples, a distance between two opposite edges of the opening can be adjustable. In one or all examples, the curved edge can include a pliable material. In one or all examples, the curved edge can include a rigid material.

Yet another aspect of the present disclosure relates to a radiation detector including an imaging array. The imaging array can include a plurality of data lines and a plurality of gate lines on a substrate. At least one line of the plurality of data lines or the plurality of gate lines can include a first portion, and a second portion aligned with and separated from the first portion. The substrate can be discontinuous between the first portion and the second portion.

In one or all examples, the imaging array can further include a first line controller coupled to the first portion and a second line controller coupled to the second portion. In one or all examples, each of the lines of the plurality of data lines or the plurality of gate lines can include a first portion, and a second portion aligned with and separated from the first portion. Each of the first portions can be coupled to the first line controller. Each of the second portions can be coupled to the second controller.

In one or all examples, the lines of the plurality of data lines or the plurality of gate lines can have varying lengths. In one or all examples, the lines of the plurality of data lines and the plurality of gate lines can have varying lengths. In one or all examples, the radiation detector can further include a housing at least partially surrounding the imaging array. The housing can include a concave edge. The concave edge can separate the first portion from the second portion.

### BRIEF DESCRIPTION OF THE DRAWINGS

The disclosure will be readily understood by the following detailed description in conjunction with the accompanying drawings, wherein like reference numerals designate like structural elements, and in which:

FIG. 1 is a block diagram of a radiation imaging system.

FIG. 2 is a top-down view of a radiation detector performing radiation imaging.

FIG. 3 is a top-down view of a radiation detector.

FIG. 4 is a top-down view of a radiation detector.

FIG. 5 is a top-down view of a radiation detector.

FIGS. 6A, 6B, and 6C are schematic views of collimators.

### DETAILED DESCRIPTION

Reference will now be made in detail to representative embodiments illustrated in the accompanying drawings. It should be understood that the following descriptions are not intended to limit the embodiments to one preferred embodiment. To the contrary, it is intended to cover alternatives, modifications, and equivalents as can be included within the spirit and scope of the described embodiments as defined by the appended claims.

The following disclosure relates to radiation detectors, radiation collimators, and radiation imaging systems that can be used to generate, shape, and detect radiation, such as x-rays. Radiation detectors can be used for imaging in a variety of contexts, including, but not limited to medical imaging, diagnostics, radiotherapy, non-destructive testing, materials detection or analysis, security inspection, and the like. In a medical setting, radiation imaging systems and methods can be used to create images of a body's internal structures. In an industrial setting, radiation imaging systems and methods can be used to image internal structures in baggage, cars, cargo, other containers and objects, and the like.

More specifically, the following disclosure relates to radiation detectors that include one or more curved edges or surfaces. The curved edges can correspond to curved surfaces of objects to be scanned by the radiation detectors. The curved edges can match, complement, correspond to, or conform to projections or outlines of curved surfaces of the objects to be scanned such that the radiation detectors can interface in close proximity to the curved surfaces of the objects to be scanned. The radiation detectors can achieve a variety of improvements, including improved imaging, comfort, durability, longevity, and reduced cost. The following disclosure further relates to radiation collimators that can be used to shape radiation to have an area corresponding to the shape of the aforementioned radiation detectors. Such radiation collimators can limit or prevent subjects or objects disposed outside of the area of the radiation detectors from being exposed to radiation.

Radiation detectors can include flat panel detectors (FPDs) that include direct or indirect X-ray conversion sensors, film-based detectors, computed radiography (CR) detectors, photon counting detectors (PCDs), or other radiation detectors. In one or all examples, a flat panel radiation detector can include a sensor array configured to detect incident radiation and a housing at least partially surrounding the sensor array. Conventionally, sensor arrays and housings of radiation detectors can have rectangular shapes. In a mammography context, one of the straight edges of the housing of a radiation detector can be pressed into a patient (e.g., into a patient’s chest) to image as much area of the patient’s breast as possible. This can cause the patient pain and portions of the breast can be missed or poorly imaged due to the mismatch between the shape of the radiation detector and the shape of the portion of the patient’s body against which the radiation detector is pressed.

Radiation detectors of the present disclosure can include components with one or more curved edges that can complement or match curved surfaces of a subject (e.g., a patient) or an object to be imaged. For example, a housing of a radiation detector and a sensor array in the housing (e.g., including a transparent substrate, such as a glass or plastic substrate, pixels, and conductive lines) can include curved edges, which can have shapes complementary to or matching surfaces of a subject or object to be imaged. In a mammography context, the housing and the sensor array of a radiation detector can include concave edges with radii complementary to an average human chest wall. This can allow the radiation detector to be placed in close proximity to a chest wall during a mammography procedure, which can allow for an entire breast to be comfortably imaged and can improve image quality and patient comfort. In other contexts, a radiation detector can be placed in close proximity to any portion of a patient’s body or an object to be imaged without damaging or harming the patient or the object and the patient or object can be imaged with improved image quality.

The present disclosure focuses on radiation detectors that can be used for mammography. However, the teachings of the present disclosure can be used with radiation detectors for any applications. For example, radiation detectors can include curved edges that correspond to curved surfaces of any objects, subjects (e.g., patients), body parts, or the like to be imaged. Providing such curved edges can allow for the radiation detectors to be placed in closer proximity to the objects to be imaged and can provide improved imaging of such objects due to this proximity. Further, the present disclosure focuses on flat panel detectors that include digital sensor arrays. However, the teachings of the present disclosure can be used with any type of radiation detectors, including film-based detectors, computed radiography (CR) detectors, photon counting detectors (PCDs), or other radiation detectors.

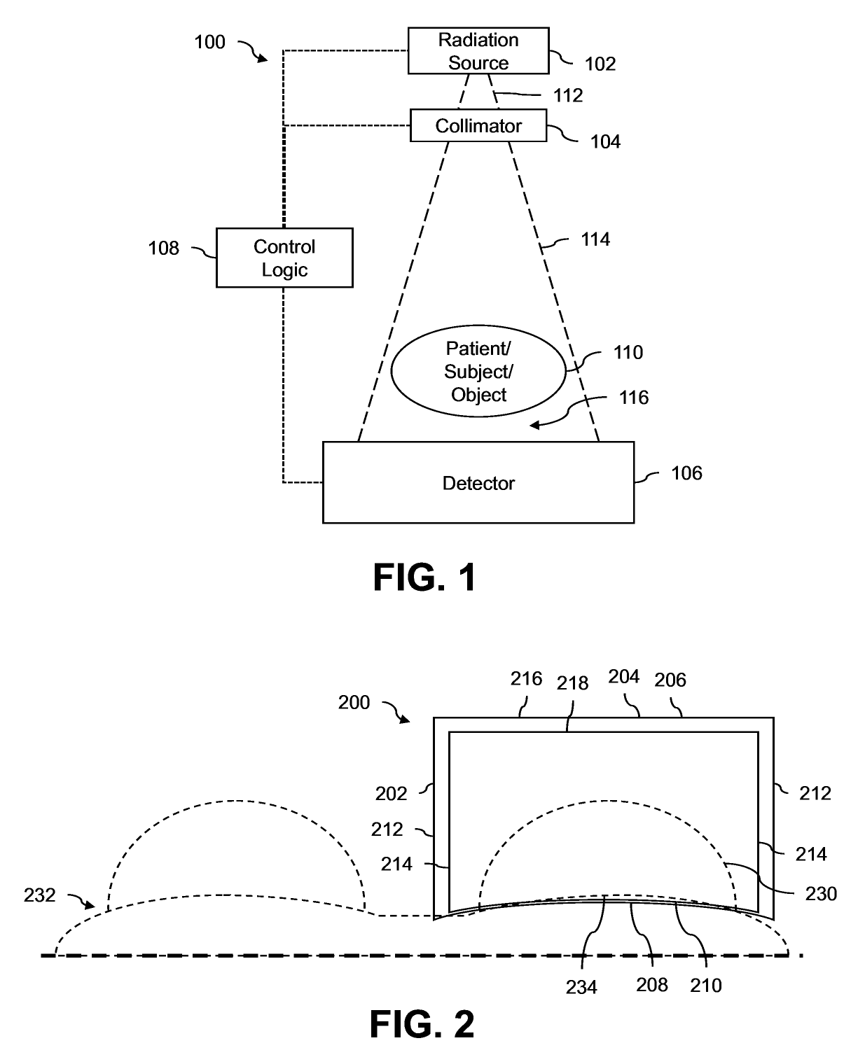

These and other examples are discussed below with reference to FIGS. 1 through 6C. However, those skilled in the art will readily appreciate that the detailed description given herein with respect to these figures is for explanatory purposes only and should not be construed as limiting. Furthermore, as used herein, a system, a method, an article, a component, a feature, or a sub-feature including at least one of a first option, a second option, or a third option should be understood as referring to a system, a method, an article, a component, a feature, or a sub-feature that can include one of each listed option (e.g., only one of the first option, only one of the second option, or only one of the third option), multiple of a single listed option (e.g., two or more of the first option), two options simultaneously (e.g., one of the first option and one of the second option), or combination thereof (e.g., two of the first option and one of the second option).

FIG. 1 illustrates a block diagram of a radiation imaging system 100. The radiation imaging system 100 includes a radiation source 102, a collimator 104, a detector 106, and control logic 108. The radiation imaging system 100 can be used to perform radiation imaging on an object 110, such as a subject or a patient.

The radiation source 102 can generate radiation 112, which can be directed towards the object 110. In one or all examples, the radiation 112 can include x-rays. The radiation source 102 can include an x-ray tube, a linear accelerator, or the like. The radiation 112 can be directed through the collimator 104.

The collimator 104 can shape the radiation 112 to shaped radiation 114 (e.g., a shaped radiation beam) so that an area of the shaped radiation 114 projected on the detector 106 matches an imaging area of the detector 106. The collimator 104 can include an opening through which the radiation 112 passes to produce the shaped radiation 114. The opening can have a shape complementary to a shape of the detector 106 (e.g., the shape of the imaging area of the detector 106). By matching the area of the shaped radiation 114 projected on the detector 106 to the imaging area of the detector 106, exposure of any areas of the object 110 outside the imaging area of the detector 106 to radiation is reduced or prevented.

In one or all examples, the radiation source 102 can be moved between multiple positions to image the object 110 from multiple angles. In such examples, the opening of the collimator 104 can have a dynamic shape such that the area of the shaped radiation 114 projected on the detector 106 matches or approximates the imaging area of the detector 106 in each position of the radiation source in which radiation imaging is performed. Thus, the radiation imaging system 100 can perform multiple exposures at different angles without unnecessarily exposing areas of the object 110 outside the area of the detector 106 to radiation.

The shaped radiation 114 can pass through and be attenuated by the object 110. Attenuated radiation 116 can be received by the detector 106, which can be configured to acquire data in response to incident radiation (e.g., x-rays or the like). In other words, the detector 106 can perform radiation imaging in response to the attenuated radiation 116 detected by the detector 106. The detector 106 can generate data including image data, video data, and the like.

As will be discussed in detail below, the detector 106 can include one or more curved edges. A curved edge of the detector 106 can have a shape complementary to a curved surface of the object 110, such as a torso of a patient. The curved edge of the detector 106 can be positioned adjacent to the curved surface of the object 110 and can allow the detector 106 or a larger area thereof to be placed in closer proximity to the object 110. This can be used to image a larger portion of the object 110, provide improved imaging quality, and prevent pain, discomfort, or damage to the object 110. The curved edge can be a side surface or sidewall of the detector 106. Although the curved edge is referred to as an edge, the curved edge of the detector 106 can be defined by a housing of the detector 106, can have a thickness, and can be a curved surface of the detector 106. The curved edge can be adjacent to, rather than part of, a detection surface of the detector 106. The curved edge can extend between two side surfaces or sidewalls of the detector 106 (e.g., between two side edges of the detector 106 in a two-dimensional view) in a direction generally or substantially parallel to a major surface of a sensor array of the detector 106. The curved edge can be defined by a housing material of the detector 106, which may be substantially rigid. The curved edge can extend in a direction generally or substantially perpendicular to major surfaces of the sensor array and the detector 106 (e.g., parallel to a direction normal to the major surfaces of the sensor array and the detector 106).

The control logic 108 can be coupled to any of the radiation source 102, the collimator 104, and/or the detector 106. The control logic 108 can control radiation generated by the radiation source 102 (e.g., exposures provided by the radiation source 102). The control logic 108 can control the position, angle, and/or movement of the radiation source 102, such as to move the radiation source 102 through one or more positions relative to the object 110 and the detector 106. In one or all examples, the control logic 108 can control the collimator 104, such as to vary the shape of the opening in the collimator 104 in accordance with the relative position of the radiation source 102 and the detector 106. The control logic 108 can control the detector 106 to capture the attenuated radiation 116.

The control logic 108 can include a general purpose processor, a digital signal processor (DSP), an application specific integrated circuit, a microcontroller, a programmable logic device, discrete circuits, a combination of such devices, or the like. The control logic 108 can include internal portions, such as registers, cache memory, processing cores, or the like, and can also include external interfaces, such as address and data bus interfaces, interrupt interfaces, or the like. In addition, the control logic 108 can include interface devices, such as logic chipsets, hubs, memory controllers, communication interfaces, or the like. The control logic 108 connects the radiation imaging system 100 to internal and external components.

In a mammography context, the radiation source 102 can be positioned directly above the object 110 (e.g., a patient’s breast) with the object 110 between the radiation source 102 and the detector 106 in a direction perpendicular to a major surface of the detector 106 (e.g., in a direction perpendicular to an imaging surface or imaging area of the detector 106). In one or all examples, the radiation source 102 can be positioned diagonally relative to the major surface, imaging surface, and/or imaging area of the detector 106. For example, the radiation source 102 can be positioned forward relative to the object 110 and an angle between the radiation source 102 and the detector 106 can be oblique relative to the major surface, the imaging surface, and/or the imaging area of the detector 106.

In one or all examples, the radiation imaging system 100 can further include one or more components for positioning the object 110 relative to the detector 106. For example, in the mammography context, the object 110 (e.g., a patient’s breast) can be placed between a paddle (referred to as a positioning component) and the detector 106. The positioning component can retain the object 110 in a desired position relative to the detector 106, can apply pressure to the object 110 if desired, and the like. The positioning component can be formed from a material that is relatively transparent to incident radiation, such that radiation can pass through the positioning component without attenuation or with relatively little attenuation. The positioning component can be formed from any material that is relatively transparent to incident radiation, such as plastics or the like. The positioning component can include a curved edge proximal to the object that can be the same as or similar to the curved edge of the detector 106, described throughout the present disclosure. For example, the positioning component can have a shape complementary to a curved surface of the object 110, such as a torso of a patient. The curved edge of the positioning component can be positioned adjacent to the curved surface of the object 110 and can allow the positioning component to be placed in close proximity to the object 110, while preventing pain, discomfort, or damage to the object 110.

FIG. 2 illustrates a top-down view of a radiation detector 200 performing radiation imaging on a breast 230 of a patient 232. The radiation detector 200 can be the same as or similar to the detector 106, discussed above with respect to FIG. 1. The patient 232 can be an example of an object 110 to be imaged, as discussed above with respect to FIG. 1. As illustrated in FIG. 2, the radiation detector 200 can be placed in close proximity to a chest wall 234 of the patient 232.

The radiation detector 200 and subsequent radiation detectors are illustrated and discussed in the context of a detector used in mammography and positioned against a patient’s chest wall 234. However, the radiation detectors disclosed herein can include any form of radiation detector and can be configured to be positioned in proximity to any object to be imaged or anywhere on a human body. Thus, the following description is not intended to limit the scope of the disclosure but is merely representative of one of various examples.

The radiation detector 200 can include a sensor array 202 positioned within a housing 204. An X-ray or radiation transparent panel 206, such as a carbon fiber, plastic, or glass panel, can be positioned over the sensor array 202. The sensor array 202 can be configured to generate an image in response to incident radiation. The sensor array 202 can include a variety of sensors configured to generate data based on incident radiation. The sensor array 202 can include any combination of direct conversion sensors, indirect conversion sensors, photon counters, radiation conversion materials (e.g., scintillator materials), or the like. The sensor array 202 can have a transparent substrate such as a plastic substrate, a glass substrate, or the like. The sensor array 202 can be a dual-layer imager or the like. The present disclosure is largely described in the context of flat panel radiation detectors that include a digital sensor array for the sensor array 202. However, the sensor array 202 can include or be replaced by any radiation sensitive area, such as a radiographic film, photostimulable phosphors (PSPs), or the like. As such, the radiation detector 200 be any type of radiation detector, such as a flat panel detector, a film-based detector, a computed radiography (CR) detector, a photon counting detector (PCD), or another type of radiation detector.

The transparent panel 206 can be relatively transparent to incident radiation. The transparent panel 206 can allow the incident radiation to pass through the transparent panel 206 to the sensor array 202 without attenuation or with relatively little attenuation. The transparent panel 206 can also provide protection to the sensor array 202. The transparent panel 206 can be formed from any material that is relatively transparent to incident radiation, such as plastics or the like. The transparent panel 206 can have the same or a similar shape to the housing 204 or the sensor array 202. In one or all examples, the sensor array 202, the housing 204, and the transparent panel 206 can have the same shape or a corresponding shape but can, in one or all examples, have different dimensions from one another. For example, each of the sensor array 202, the housing 204, and the transparent panel 206 can have three straight edges and a curved edge extending between opposite straight edges. The housing 204 can have the largest dimensions (e.g., length and width), the sensor array 202 can have the smallest dimensions, and the transparent panel 206 can have dimensions between the sensor array 202 and the housing 204. As such, the following teachings that reference edges of the sensor array 202 and the housing 204 can also apply to the transparent panel 206.

As illustrated in FIG. 2, the housing 204 can include a curved edge 208, a pair of straight edges 212 opposite one another, and a straight edge 216 opposite the curved edge 208. The curved edge 208 can extend between the straight edges 212. The sensor array 202 can include a curved edge 210, a pair of straight edges 214 opposite one another, and a straight edge 218 opposite the curved edge 210. The curved edge 210 can extend between the straight edges 214. The curved edge 208 of the housing 204 can have a curvature that corresponds to a curvature of the chest wall 234, or an average human chest wall. The curved edge 210 of the sensor array 202 can have a curvature that corresponds to the curvature of the curved edge 208 such that the sensor array 202 is as close as possible to the curved edge 208 of the housing 204. The curved edges 208, 210 can have concave shapes corresponding to the convex shape of the chest wall 234. This can allow for the radiation detector 200 and the sensor array 202 thereof to be placed in close proximity to the chest wall 234 such that a larger proportion of the breast 230 can be imaged by the radiation detector 200. Further, the radiation detector 200 and the sensor array 202 can be placed in close proximity to the chest wall 234 without requiring the radiation detector to be pressed into the chest wall 234, which can reduce pain and discomfort for the patient 232.

The thickness of the housing 204 between the sensor array 202 and an object to be imaged (e.g., the thickness and distance between the curved edge 208 and the sensor array 202) can be minimized so that the distance between the sensor array 202 and the object to be imaged is minimized. This allows the sensor array 202 to be closer to the object to be imaged and allows the sensor array 202 to capture a maximum area of the object to be imaged, thereby improving image quality. The thickness of the housing 204 between the sensor array 202 and the object to be imaged can be about 1 mm, less than about 1 mm, less than about 2 mm, less than about 5 mm, or the like.

The curved edges 208, 210 can have any desired curvature, depending on the application of the radiation detector 200. In the example illustrated in FIG. 2, the curved edges 208, 210 are both symmetrical. For example, each of the curved edges 208, 210 can be symmetrical about an axis defined along a length of the respective curved edge 208, 210, such as about an axis defined centrally along the length of the respective curved edge 208, 210. The axis can extend in a direction perpendicular to the respective curved edge 208, 210. However, the curved edges 208, 210 can be asymmetrical. For example, each of the curved edges 208, 210 can be asymmetrical about an axis defined along a length of the respective curved edge 208, 210, such as about an axis defined centrally along the length of the respective curved edge 208, 210. In a mammography context, the curved edges 208, 210 can be symmetrical such that the same radiation detector 200 can be used to image both of the patient’s breasts 230. The curved edges 208, 210 can be asymmetrical such that one radiation detector 200 can be used to image the patient’s left breast 230 and another radiation detector 200 can be used to image the patient’s right breast 230. This can increase cost, but can also further improve patient comfort, image quality, and the like. In examples in which the curved edges 208, 210 are asymmetrical, the straight edges 212, 214 on opposite sides of the radiation detector 200 can have different lengths from one another.

In one or all examples, the radiation detector 200 can include sensor arrays 202 or radiation sensitive areas on opposite sides of the radiation detector 200, or the sensor array 202 or radiation sensitive areas can be sensitive to incident radiation directed towards the radiation detector 200 from opposite directions. In examples in which the curved edges 208, 210 are asymmetrical, this can allow the radiation detector 200 to be flipped and used to image objects having different curves depending on the orientation of the radiation detector 200. For example, in a mammography context, the radiation detector 200 can be used to image a patient’s left breast, flipped, and used to image a patient’s right breast. This can reduce cost relative to having two radiation detectors with different asymmetric curved edges 208, 210 while further improving patient comfort, image quality, and the like. Any of the radiation detectors described herein can be sensitive to incident radiation from opposite sides of the respective radiation detector.

The curved edges 208, 210 can have constant radiuses of curvature or varying radiuses of curvature. For example, as illustrated in FIG. 2, the curved edges 208, 210 can be more curved towards the straight edges 212, 214 and flatter towards the center of the curved edges 208, 210. Although the curved edges 208, 210 are illustrated as having concave shapes, the curved edges 208, 210 can have convex shapes or combinations of concave and convex shapes. The curved edges 208, 210 can have any combination of curves, flats, straights, or the like to fit an application for the radiation detector 200.

FIG. 2 illustrates a single curved edge 208, 210 for each of the housing 204 and the sensor array 202. However, in one or all examples, the housing 204 and the sensor array 202 can include multiple curved edges. For example, two edges of the housing 204 and the sensor array 202 can be curved with different curvatures, and the edge with a more appropriate curvature for a specific application can be placed proximal to an object to be imaged. In one or all examples, two edges of the housing 204 and the sensor array 202 can be curved to interface with two curved surfaces of an object to be imaged. The housing 204 and the sensor array 202 can include any number of curved surfaces depending on applications for which the radiation detector 200 is used.

The curved edges 208, 210 can be side surfaces or sidewalls of the housing 204, the sensor array 202, and the transparent panel 206. The curved edges 208, 210 can be adjacent to, rather than part of, detection surfaces of the detector 200 and the sensor array 202. The curved edges 208, 210 can extend between the straight edges 212, 214 in a direction generally or substantially parallel to a major surface of the sensor array 202 and the transparent panel 206. The curved edge 208 can be defined by a housing material of the housing 204, which may be substantially rigid. Surfaces of the curved edges 208, 210 can extend in a direction generally or substantially perpendicular to major surfaces of the sensor array 202 and the transparent panel 206 (e.g., parallel to a direction normal to the major surfaces of the sensor array 202 and the transparent panel 206).

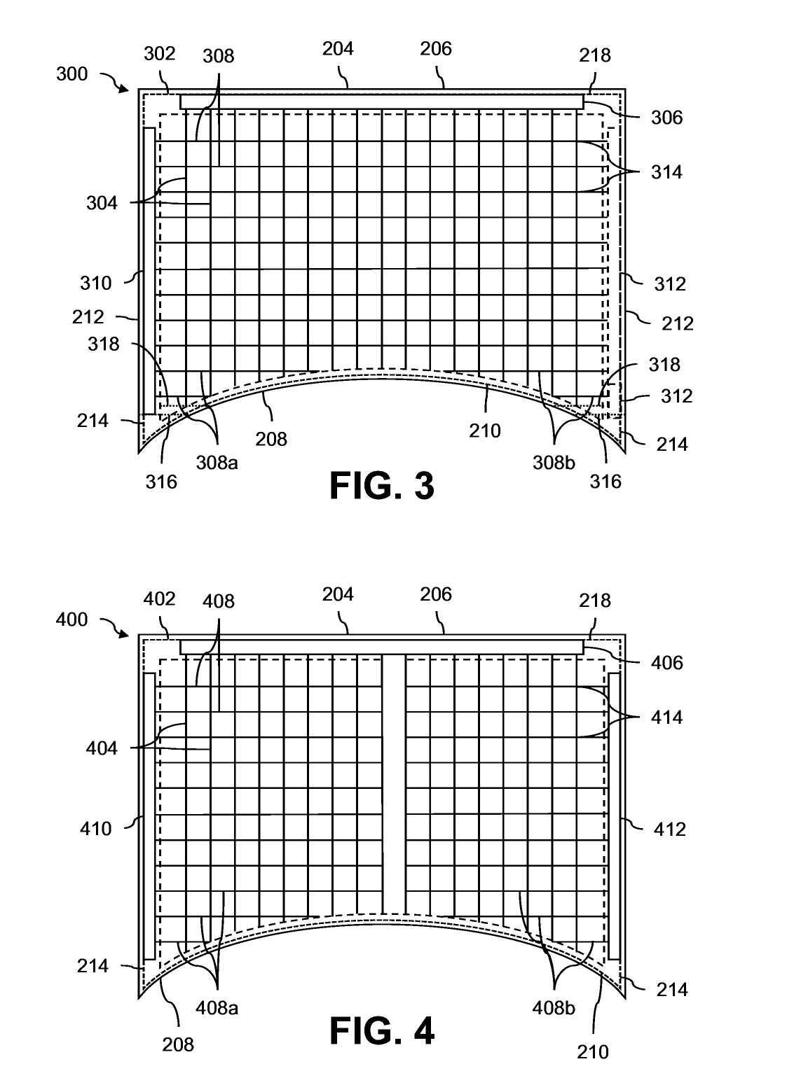

FIGS. 3 through 5 illustrate top-down views of radiation detectors in accordance with one or all examples. More specifically, FIGS. 3 through 5 illustrate various configurations of the sensor arrays of radiation detectors. Each of the radiation detectors illustrated in FIGS. 3 through 5 can be the same as, or similar to, the radiation detectors 106, 200, discussed above with respect to FIGS. 1 and 2. For example, each of the radiation detectors illustrated in FIGS. 3 through 5 can have a sensor array, a housing 204, and a transparent panel 206 shaped as described above with respect to FIGS. 1 and 2. FIGS. 3 through 5 describe different configurations for lines and controllers in the sensor arrays of the radiation detectors.

FIG. 3 illustrates a radiation detector 300 including a sensor array 302. The sensor array 302 can include a plurality of first lines 304 coupled to a first controller 306 and a plurality of second lines 308 coupled to a second controller 310 or a third controller 312. Each of the first lines 304 can extend in a first direction, and each of the second lines 308 can extend in a second direction substantially perpendicular to the first lines 304. Pixels 314 can be positioned adjacent to the first lines 304 and the second lines 308 and the pixels 314 can be coupled to the first lines 304 and the second lines 308 at each intersection of the first lines 304 and the second lines 308. The pixels 314 can detect incident radiation. The plurality of first lines 304 or the plurality of second lines 308 can include a plurality of gate lines and the other of the plurality of first lines 304 or the plurality of second lines 308 can include a plurality of data lines. The first lines 304 or the second lines 308 can be used to read data from the pixels. The first controller 306 can be used to control the first lines 304 or read data from the first lines 304. The second controller 310 and the third controller 312 can be used to control the second lines 308 or read data from the second lines 308.

As described above, the sensor array 302 can have a non-rectangular shape. Specifically, the sensor array 302 can have a curved edge 210, two parallel straight edges 214, and a straight edge 218 opposite the curved edge 210. To maximize the number of pixels 314 in the sensor array 302 and minimize the proximity of the pixels 314 to an object to be imaged, the first lines 304 and the second lines 308 can have varying line lengths and some of the second lines 308 can be split lines.

Each of the first lines 304 can be coupled to the first controller 306 and can extend from the first controller 306 to a pixel 314 closest to the curved edge 210 of the sensor array 302. The length of each of the first lines 304 depends on where along the curved edge 210 the first line 304 is located. Thus, the first lines 304 positioned proximal the straight edges 214 of the sensor array 302 can have relatively long lengths and the first lines 304 positioned towards the center of the sensor array 302 and distal the straight edges 214 can have relatively short line lengths. This helps to maximize the area of an object to be imaged that can be captured and imaged by the sensor array 302.

The plurality of second lines 308 can include split lines 308a and 308b. Because the housing 204 and the sensor array 302 include the curved edges 208, 210, some of the second lines 308 cannot extend continuously across the sensor array 302. In other words, the concave curved edges 208, 210 separate portions of the second lines 308 from one another, resulting in the split lines 308a, 308b. A substrate of the sensor array 302 can be shaped with the curved edge 210 and can be discontinuous between the split lines 308a, 308b. The split lines 308a can be coupled to the second controller 310. The split lines 308b can be coupled to the third controller 312. In one or all examples, the remainder of the plurality of second lines 308 that extend across the sensor array 302 can be coupled to the second controller 310 or the third controller 312. For example, all of the remainder of the plurality of second lines 308 that extend across the sensor array 302 can be coupled to the second controller 310 or the third controller 312, or some of the remainder of the plurality of second lines 308 can be coupled to the second controller 310 and some of the remainder of the plurality of second lines 308 can be coupled to the third controller 312. The second and third controllers 310, 312 can have different lengths depending on the second lines 308 that are coupled to each of the second and third controllers 310, 312.

By including both the second controller 310 and the third controller 312, the pixels 314 in corner areas of the sensor array 302 can be read, even as the pixels 314 are connected to the split lines 308a, 308b. This helps to maximize the area of an object to be imaged that can be captured and imaged by the sensor array 302. More specifically, this allows the sensor array 302 to capture radiation data from corner areas while including a concave curved edge 210. The relatively shorter first lines 304 and second lines 308 included in the sensor array 302 can have less noise and can provide improved signals from the radiation detector 300.

FIG. 3 illustrates a particular number of first lines 304, second lines 308, and pixels 314 for illustrative purposes. However, the sensor array 302 can include any number of first lines 304, second lines 308, and pixels 314. For example, the sensor array 302 can include tens, hundreds, thousands, or more first lines 304 and second lines 308, as well as a corresponding number of pixels 314.

FIG. 3 is illustrated with the curved edge 208 extending from one of the straight edges 212 to an opposite straight edge 212 and the curved edge 210 extending from one of the straight edges 214 to an opposite straight edge 214. However, edges of the housing 204 and the sensor array 302 in which the curved edges 208, 210 are defined can include one or more straight edges. For example, the edge of the housing 204 that extends from one of the straight edges 212 to an opposite straight edge 212 can be defined by straight edges 316 and the curved edge 208. Specifically, a first straight edge 316 can extend from one of the straight edges 212 to the curved edge 208, the curved edge 208 can extend from the first straight edge 316 to a second straight edge 316, and the second straight edge 316 can extend from the curved edge 208 to the opposite straight edge 212. Similarly, the edge of the sensor array 302 that extends from one of the straight edges 214 to an opposite straight edge 214 can be defined by straight edges 318 and the curved edge 210. Specifically, a first straight edge 318 can extend from one of the straight edges 214 to the curved edge 210, the curved edge 210 can extend from the first straight edge 318 to a second straight edge 318, and the second straight edge 318 can extend from the curved edge 210 to the opposite straight edge 214. The straight edges 316, 318 can have any desired lengths, can be disposed at any desired angles relative to the straight edges 212, 214 and the curved edges 208, 210, and can be symmetrical or asymmetrical (e.g., can have the same or different lengths). Moreover, any of the radiation detectors described herein can include straight edges along an edge in which curved edges are defined.

FIG. 4 illustrates a radiation detector 400 including a sensor array 402. The sensor array 402 can include a plurality of first lines 404 coupled to a first controller 406 and a plurality of second lines 408 coupled to a second controller 410 or a third controller 412. Each of the first lines 404 can extend in a first direction and each of the second lines 408 can extend in a second direction perpendicular to the first lines 404. Pixels 414 can be positioned adjacent to the first lines 404 and the second lines 408 and the pixels 414 can be coupled to the first lines 404 and the second lines 408 at each intersection of the first lines 404 and the second lines 408. The pixels 414 can detect incident radiation. The plurality of first lines 404 or the plurality of second lines 408 can include a plurality of gate lines and the other of the plurality of first lines 404 or the plurality of second lines 408 can include a plurality of data lines. The first lines 404 or the second lines 408 can be used to read data from the pixels. The first controller 406 can be used to control the first lines 404 or read data from the first lines 404. The second controller 410 and the third controller 412 can be used to control the second lines 408 or read data from the second lines 408.

As described above, the sensor array 402 can have a non-rectangular shape. Specifically, the sensor array 402 can have a curved edge 210, two substantially parallel straight edges 214, and a substantially straight edge 218 opposite the curved edge 210. To maximize the number of pixels 414 in the sensor array 402 and minimize the proximity of the pixels 414 to an object to be imaged, the first lines 404 and the second lines 408 can have varying line lengths and the second lines 408 can be split lines.

Each of the first lines 404 can be coupled to the first controller 406 and can extend from the first controller 406 to a pixel 414 closest to the curved edge 210 of the sensor array 402. The length of each of the first lines 404 depends on where along the curved edge 210 the first line 404 is located. Thus, the first lines 404 positioned proximal the straight edges 214 of the sensor array 402 can have relatively long lengths and the first lines 404 positioned towards the center of the sensor array 402 and distal the straight edges 214 can have relatively short line lengths. This helps to maximize the area of an object to be imaged that can be captured and imaged by the sensor array 402.

Each of the second lines 408 can include split lines 408a and 408b. The split lines 408a can be coupled to the second controller 410. The split lines 408b can be coupled to the third controller 412. By splitting all the second lines 408 into split lines 408a, 408b, the lengths of the second lines 408 can be reduced and noise through the second lines 408 can be reduced, improving signal quality from the second lines 408. By including both the second controller 410 and the third controller 412, the pixels 414 in corner areas of the sensor array 402 can be read. This helps to maximize the area of an object to be imaged that can be captured and imaged by the sensor array 402. More specifically, this allows the sensor array 402 to capture radiation data from corner areas while including a concave curved edge 210.

As illustrated in FIG. 4, the split lines 408a, 408b can have varying line lengths. For example, a number of the split lines 408a, 408b proximal the curved edge 210 can have reduced line lengths, and a remainder of the split lines 408a, 408b can have the same line lengths. Because the housing 204 and the sensor array 402 include the curved edges 208, 210, some of the second lines 408 cannot extend continuously across the sensor array 402. In other words, the concave curved edges 208, 210 separate portions of the second lines 408 from one another, resulting in the split lines 408a, 408b proximal the curved edge 210 having reduced line lengths. A substrate of the sensor array 402 can be shaped with the curved edge 210 and can be discontinuous between the split lines 408a, 408b. Further, the split lines 408a can have different lengths from the split lines 408b. For example, each of the split lines 408a can have longer lengths relative to the split lines 408b. However, the split lines 408a can have the same lengths as the split lines 408b.

FIG. 4 illustrates a particular number of first lines 404, second lines 408, and pixels 414 for illustrative purposes. However, the sensor array 402 can include any number of first lines 404, second lines 408, and pixels 414. For example, the sensor array 402 can include tens, hundreds, thousands, or more first lines 404 and second lines 408 and a corresponding number of pixels 414.

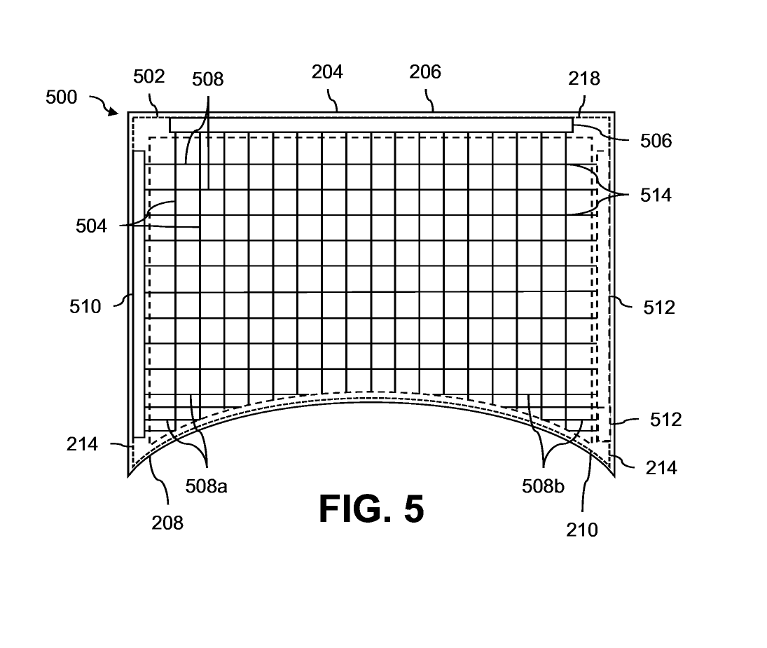

FIG. 5 illustrates a radiation detector 500 including a sensor array 502. The sensor array 502 can include a plurality of first lines 504 coupled to a first controller 506 and a plurality of second lines 508 coupled to a second controller 510 or a third controller 512. Each of the first lines 504 can extend in a first direction and each of the second lines 508 can extend in a second direction perpendicular to the first lines 504. Pixels 514 can be positioned adjacent to the first lines 504 and the second lines 508 and the pixels 514 can be coupled to the first lines 504 and the second lines 508 at each intersection of the first lines 504 and the second lines 508. The pixels 514 can detect incident radiation. The plurality of first lines 504 or the plurality of second lines 508 can include a plurality of gate lines and the other of the plurality of first lines 504 or the plurality of second lines 508 can include a plurality of data lines. The first lines 504 or the second lines 508 can be used to read data from the pixels. The first controller 506 can be used to control the first lines 504 or read data from the first lines 504. The second controller 510 and the third controller 512 can be used to control the second lines 508 or read data from the second lines 508.

As described above, the sensor array 502 can have a non-rectangular shape. Specifically, the sensor array 502 can have a curved edge 210, two parallel straight edges 214, and a straight edge 218 opposite the curved edge 210. To maximize the number of pixels 514 in the sensor array 502 and minimize the proximity of the pixels 514 to an object to be imaged, the first lines 504 and the second lines 508 can have varying line lengths and some of the second lines 508 can be split lines.

Each of the first lines 504 can be coupled to the first controller 506 and can extend from the first controller 506 to a pixel 514 closest to the curved edge 210 of the sensor array 502. The length of each of the first lines 504 depends on where along the curved edge 210 the first line 504 is located. Thus, the first lines 504 positioned proximal the straight edges 214 of the sensor array 502 can have relatively long lengths and the first lines 504 positioned towards the center of the sensor array 502 and distal the straight edges 214 can have relatively short line lengths. This helps to maximize the area of an object to be imaged that can be captured and imaged by the sensor array 502.

The plurality of second lines 508 can include split lines 508a and 508b. Because the housing 204 and the sensor array 502 include the curved edges 208, 210, some of the second lines 508 cannot extend continuously across the sensor array 502. In other words, the concave curved edges 208, 210 separate portions of the second lines 508 from one another, resulting in the split lines 508a, 508b. A substrate of the sensor array 502 can be shaped with the curved edge 210 and can be discontinuous between the split lines 508a, 508b. As illustrated in FIG. 5, the second lines 508 can have varying line densities. In other words, a spacing between adjacent ones of the second lines 508 can vary in the sensor array 502. The second lines 508 that extend across the sensor array 502 can have a first spacing between adjacent lines and the split lines 508a, 508b can have a second spacing between adjacent lines that is less than the first spacing. This increases the density of the pixels 514 in the corner areas of the sensor array 502 and increases the amount of data that can be collected in these areas. The pixel density can be varied throughout the sensor array 502, such as by continuously or stepwise decreasing as distance from the curved edge 210 increases.

The split lines 508a can be coupled to the second controller 510. The split lines 508b can be coupled to the third controller 512. In one or all examples, the remainder of the plurality of second lines 508 that extend across the sensor array 502 can be coupled to the second controller 510 or the third controller 512. For example, all of the remainder of the plurality of second lines 508 that extend across the sensor array 502 can be coupled to the second controller 510 or the third controller 512, or some of the remainder of the plurality of second lines 508 can be coupled to the second controller 510 and some of the remainder of the plurality of second lines 508 can be coupled to the third controller 512. The second and third controllers 510, 512 can have different lengths depending on the second lines 508 that are coupled to each of the second and third controllers 510, 512.

By including both the second controller 510 and the third controller 512, the pixels 514 in corner areas of the sensor array 502 can be read, even as the pixels 514 are connected to the split lines 508a, 508b. This helps to maximize the area of an object to be imaged that can be captured and imaged by the sensor array 502. More specifically, this allows the sensor array 502 to capture radiation data from corner areas while including a concave curved edge 210. The relatively shorter first lines 504 and second lines 508 included in the sensor array 502 can have less noise and can provide improved signals from the radiation detector 500.

FIG. 5 illustrates a particular number of first lines 504, second lines 508, and pixels 514 for illustrative purposes. However, the sensor array 502 can include any number of first lines 504, second lines 508, and pixels 514. For example, the sensor array 502 can include tens, hundreds, thousands, or more first lines 504 and second lines 508 and a corresponding number of pixels 514.

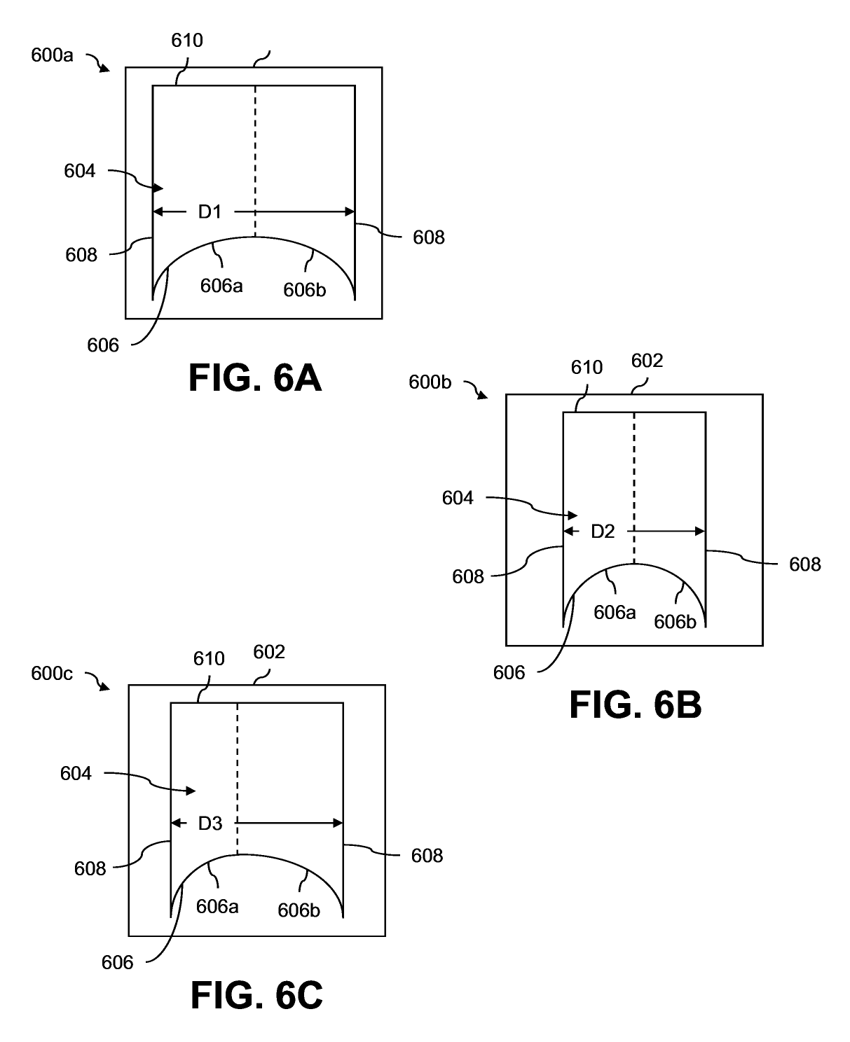

FIGS. 6A through 6C illustrate schematic views of collimators 600a-c that can be used with the radiation detectors of the present disclosure. The collimators 600a-c can be the same as, or similar to, the collimator 104 discussed above with respect to FIG. 1. In one or all examples, a radiation source can expose a radiation detector to radiation from a single angle. In such examples, a static collimator including an opening with a curved edge can be used to shape the radiation directed towards the radiation detector. In one or all examples, a radiation source can move through an exposure pattern and can expose a radiation detector to radiation from multiple angles. In such examples, a dynamic or adjustable collimator including an opening with a curved edge and an adjustable or varying shape can be used to shape the radiation directed towards the radiation detector. In one or all examples, a position of the collimator between the radiation source and the radiation detector (e.g., relative to the radiation source and/or the radiation detector) can be changed or adjusted depending on the position of the radiation source. The collimators 600a-c can be used to shape radiation directed towards the radiation detector to have the same area as the radiation detector to prevent exposure of objects (e.g., subjects, patients, or the like) or portions thereof outside the area of the radiation detector to the radiation.

The collimators 600a-c can include one or more collimation components 602 that define an opening 604. A portion of incident radiation can pass through the opening 604 as shaped radiation and a remainder of the incident radiation can be blocked by the collimation components 602. As illustrated in FIGS. 6A through 6C, each of the openings 604 can be defined by a curved edge 606, two parallel straight edges 608, and a straight edge 610 opposite the curved edge 606. The curved edge 606 can extend between the straight edges 608. The straight edges 608 can have the same or different lengths as one another. The opening 604 can have a shape complementary to a shape of a radiation detector that the collimator directs the shaped radiation towards such that the collimators 600a-c prevent exposure of areas outside the radiation detector to radiation.

The curved edge 606 can have a constant radius of curvature or a varying radius of curvature. For example, as illustrated in FIG. 6A, the curved edge 606 can be more curved towards the straight edges 608 and flatter towards the center of the curved edge 606. Although the curved edge 606 is illustrated as having a concave shape (e.g., formed by a convex-shaped material of the collimation components 602), the curved edge 606 can have a convex shape or a combination of concave and convex shapes. The collimation components 602 define side surfaces of the opening 604 and can have complementary or reciprocal shapes to the shape of the opening 604. The curved edge 606 can have any combination of curves, flats, straights, or the like to fit an application for a radiation imaging system. Further, multiple edges of the opening 604 can have curved shapes for applications as discussed above with respect to the radiation detectors 106, 200, 300, 400, 500.

Various characteristics of the collimators 600a-c can be adjustable or dynamic. For example, a radius of curvature of the curved edge 606, a symmetry of the curved edge 606, and a distance between the straight edges 608 can be adjustable. The collimators 600a-c can include one or more collimation components 602, which can move relative to one another and/or can move relative to a radiation source to define the opening 604 relative to the radiation source and a radiation detector. To change the opening 604 defined by the collimation components 602 (and characteristics of the edges 606, 608, 610), the collimation components 602 can include multiple pieces that move or adjust relative to one another, that form an iris that can open and close to change a curve, or the like. The collimation components 602 can include a pliant surface that can be moved by an actuator to change a symmetry or curvature of the curved edge 606. The collimators 600a-c can be moved towards or away from the radiation source and/or the radiation detector to adjust an effective size of the opening 604. The collimators 600a-c can be angled relative to the radiation source and/or the radiation detector to adjust an effective shape of the opening 604. The collimation components 602 can be adjusted to adjust the opening 604 as the radiation source moves through different angles relative to the radiation detector.

FIG. 6A illustrates an example in which the collimation components 602 of the collimator 600a define an opening 604 with a symmetrical curved edge 606. For example, the curved edge 606 can be symmetrical about an axis defined along a length of the curved edge 606, such as about an axis defined centrally along the length of the curved edge 606. The axis can extend in a direction perpendicular to the curved edge 606. The straight edges 608 can be separated from one another by a distance D1. In FIG. 6B, the collimation components 602 can be adjusted to the collimator 600b to define an opening 604 with a symmetrical curved edge 606. For example, the curved edge 606 can be asymmetrical about an axis defined along a length of the curved edge 606, such as about an axis defined centrally along the length of the curved edge 606. The straight edges 608 can be separated from one another by a distance D2, which can be less than the distance D1. The curved edge 606 can have a more curved radius of curvature relative to the collimator 600a. In FIG. 6C, the collimation components 602 can be adjusted to the collimator 600c to define an opening 604 with an asymmetrical curved edge 606. The straight edges 608 can be separated from one another by a distance D3, which can be less than the distance D1 and greater than the distance D2. A left portion 606a of the curved edge 606 can have a radius of curvature the same as a left portion 606a of the curved edge 606 of the collimator 600b. A right portion 606b of the curved edge 606 can have a radius of curvature the same as a right portion 606b of the curved edge 606 of the collimator 600a. The curved edge 606 can have a more curved radius of curvature relative to the collimator 600a. FIGS. 6A-6C illustrate a subset of operations that can be performed using the adjustable collimators 600a-c with collimation components 602. Any other adjustments can be made through the collimation components 602 to adjust the opening 604 depending on the relative positions of the radiation source and the radiation detector to ensure that radiation does not extend outside the area of the radiation detector.

The collimators 600a-c can include any number of collimation components 602 in order to provide the level of adjustment for a given application of a radiation imaging system. The collimation components 602 can be formed from materials that are relatively opaque to incident radiation such that incident radiation does not pass through the collimators 600a-c outside of the opening 604. For example, the collimation components 602 can be formed from lead, tungsten, molybdenum, high-density plastics, or the like. The collimation components 602 can be formed from rigid materials or pliant materials. For example, in one or all examples, portions of the collimation components 602 that define the curved edge 606 can be formed from pliant materials, which allow the curved edge 606 to be adjusted by an actuator.

The curved edge 606 can be defined by a side surface or sidewall of the collimator components 602. The curved edge 606 can extend between the straight edges 608 in a direction generally or substantially perpendicular to a direction in which radiation is directed towards the collimators 600a-c and a direction in which the radiation passes through the opening 604. The curved edge 606 can be adjacent to, rather than part of, major surfaces of the collimators 600a-c towards which the radiation is directed. As such, the radiation can pass through the opening 604 adjacent to the curved edge 606.

The foregoing description, for purposes of explanation, used specific nomenclature to provide a thorough understanding of the described embodiments. However, it will be apparent to one skilled in the art that the specific details are not required to practice the described embodiments. Thus, the foregoing descriptions of the specific embodiments described herein are presented for purposes of illustration and description. They are not intended to be exhaustive or to limit the embodiments to the precise forms disclosed. It will be apparent to one of ordinary skill in the art that many modifications and variations are possible in view of the above teachings.

What is claimed is:

1. A radiation detector comprising:
a radiation sensitive area configured to detect incident radiation, the radiation sensitive area comprising a concave curved edge at least partially defining the radiation sensitive area; and
a housing at least partially surrounding the radiation sensitive area, the housing comprising a concave curved edge.

2. The radiation detector of claim 1, wherein:
the housing further comprises:
a first straight edge; and
a second straight edge opposite the first straight edge; and
the concave curved edge of the housing extends between the first straight edge and the second straight edge.

3. The radiation detector of claim 1, wherein the concave curved edge of the housing is symmetrical about an axis arranged along a length of the concave curved edge of the housing.

4. The radiation detector of claim 1, wherein the concave curved edge of the housing is asymmetrical about an axis arranged along a length of the concave curved edge of the housing.

5. The radiation detector of claim 1, wherein the concave curved edge of the radiation sensitive area defines a shape complementary to the concave curved edge of the housing.

6. The radiation detector of claim 1, further comprising a radiation transparent panel over the radiation sensitive area and coupled to the housing, the radiation transparent panel comprising a curved edge having a shape complementary to the concave curved edge of the housing.

7. A radiation collimator comprising:
a collimation component configured to shape incident radiation through an opening, the opening comprising:
a first straight edge;
a second straight edge opposite the first straight edge; and
a curved edge extending between the first straight edge and the second straight edge.

8. The radiation collimator of claim 7, wherein the curved edge is symmetrical about an axis arranged along a length of the concave edge.

9. The radiation collimator of claim 7, wherein the curved edge is asymmetrical about an axis arranged along a length of the concave edge.

10. The radiation collimator of claim 7, wherein a radius of the curved edge is adjustable.

11. The radiation collimator of claim 7, wherein a symmetry of the curved edge is adjustable.

12. The radiation collimator of claim 7, wherein a distance between two opposite edges of the opening is adjustable.

13. The radiation collimator of claim 7, wherein the curved edge comprises a pliable material.

14. The radiation collimator of claim 7, wherein the curved edge comprises a rigid material.

15. A radiation detector comprising:
an imaging array comprising a plurality of data lines and a plurality of gate lines on a substrate, wherein:
at least one line of the plurality of data lines or the plurality of gate lines comprises:
a first portion; and
a second portion aligned with and separated from the first portion; and
the substrate is discontinuous between the first portion and the second portion.

16. The radiation detector of claim 15, wherein the imaging array further comprises:
a first line controller coupled to the first portion; and
a second line controller coupled to the second portion.

17. The radiation detector of claim 16, wherein:
each of the lines of the plurality of data lines or the plurality of gate lines comprises a first portion and a second portion aligned with and separated from the first portion;
each of the first portions is coupled to the first line controller; and
each of the second portions is coupled to the second controller.

18. The radiation detector of claim 15, wherein the lines of the plurality of data lines or the plurality of gate lines have varying lengths.

19. The radiation detector of claim 15, wherein the lines of the plurality of data lines and the plurality of gate lines have varying lengths.

20. The radiation detector of claim 15, further comprising a housing at least partially surrounding the imaging array, the housing comprising a concave curved edge, the concave curved edge separating the first portion from the second portion.
